(19) United States
(12) Patent Application Publication
(10) Pub. No.: US 2026/0119872 A1
(43) Pub. Date: Apr. 30, 2026

(54) Amorphous Neural Network Method and Structure

(71) Applicant: Anthony Luke Simon, West Bloomfield, MI (US)

(72) Inventor: Anthony Luke Simon, West Bloomfield, MI (US)

(21) Appl. No.: 18/925,804

(22) Filed: Oct. 24, 2024

(51) Int. Cl. G06N 3/082

(52) U.S. Cl. CPC G06N 3/082

(57) ABSTRACT

A method and structure are disclosed. An example neural network is provided comprising multiple neurons including a subset of neurons comprising a majority of the multiple neurons, wherein each neuron of the subset of neurons has upstream neurons and downstream neurons interconnected through connections in a manner such that the connections for each neuron to other neurons are unconstrained within defined limits so that the neural network has an amorphous shape that is not predefined within the constrained limits. A neurogenesis method for creating the example network is disclosed.

### BACKGROUND OF THE INVENTION

Neural networks are used to store information through a process called training. After training neural networks can be used to retrieve the stored information. They can also be used to generalize the stored information; that is, neural networks can receive inputs that they haven't seen during training, and provide a generalized output based upon the training. For example, a robust neural network used for image recognition can be trained on a set of images and then, based upon the training, accurately classify images that have not previously been provided to the network. In a known technique, neural networks have a structure defined by a person designing the neural network. The neural network structure specifies layers of neurons, the type of each layer, the number of neurons in each layer, and the type of neuron in each layer.

FIG. 1 shows a simplified example of a neural network 10 known in the art. In the figure, neural network 10 includes three input neurons 11 in input layer 12, neuron layers 14 and 16 comprising neurons 20, and output layer 18 with two output neurons 19 that provide two output signals represented by lines 24. The neurons 20 in layer 14 are fully interconnected by weights 22 to the input neurons 11, meaning each neuron 20 is connected by a weight to each input neuron 11 in layer 12. Similarly, each neuron 20 in layer 16 is fully interconnected to each neuron 20 in layer 12. And each output neuron in layer 18 is fully interconnected to the neurons 20 in layer 16.

Operation of the neural network 10 is well known in the art. In this example each input data set is represented by three pieces of information represented by input neurons 11. Each piece of information is provided as a numerical value and each is multiplied by the weights connected to the input neuron 11. The products of the multiplication of the input information and the weights are provided to the neurons in layer 14. Each neuron 20 in layer 14 sums the information provided by the set of input weights connected to that neuron and then processes that sum through an activation function which is designed to preserve the linearity of the mathematical model represented by the neural network. A typical activation function may include a ReLU, sigmoid, tanh, or any other activation function known in the art. The output of the activation function of each neuron 20 in layer 14 is multiplied by the weight 22 connecting that neuron to each neuron in layer 16. Each neuron in layer 16 sums the products from each respective weight and the output of the neurons in layer 14 and, like the neurons in layer 14, processes that product through an activation function to provide the output of each neuron in layer 16. The neurons in layer 16 provide their output to the weights connecting those neurons to the output neurons 19 in layer 18 and each output neuron 19 in layer 18 sums the product of the weights and the outputs of neurons in layer 16, which sum is provided to an activation function, the result of which is the output 24 for that neuron 19.

During a known technique for training, each output 24 is compared to the desired output corresponding to the specific input set provided through the input neurons 11 and, if the output is not the expected output, an error is determined and that error is fed back through the neural network in a known manner to adjust the weights 22 in the neural network. This process is repeated until the network learns the provided information set. In an example training for this network each input has three pieces of information and two expected outputs, and the network may be trained with several rows of inputs and expected outputs of this nature. The rows of information are cycled through the network and feedback is determined iteratively until the neural network learns the expected outputs for each input within a predetermined error threshold. Once the error of the outputs is reduced to a predetermined level, the neural network has learned the provided information and may be able to generalize information to provide correct outputs for information of similar type to the training information but on which the network was not trained.

In a typical neural network, information flow is provided successively through each layer by a control program that activates each layer of the neural network in sequence. Information is provided to the neural network in the input layer 12, through the weights connecting the input layer 12 to layer 14, through the weights connecting layer 14 to layer 16, and through the weights connecting layer 16 to layer 18. During training, for feedback, the error is propagated similarly through the neural network but in the opposite direction from the output neurons 19 to the inputs 11.

In addition to the neuron layers shown, there are other known types of neural networks layers such as, for example, convolutional layers typically used for image processing. Known modifications to the basic structure shown in FIG. 1 include resnet modifications where a layer in the network may be connected not only to its prior layer but to an earlier layer in the network. Other known modifications include using bias neurons, removing weights that have small values, and randomly creating null neurons. Readily available software provides tools to create neural networks with this layered structure. These tools allow a neural network designer to specify the number of layers, the size of the layers, and the type of the layers when they build their neural network.

Neural networks may comprise the core information storage and generalization components of artificial intelligence systems. One challenge with large scale implementations of neural networks in large artificial intelligence systems is the amount of power consumption necessary to train the neural network which directly correlates to the cost of training the neural network and the energy used during training. The processing of a large neural network can cost $10 million or more for a single training session. For a network that needs to be updated regularly, the total training costs rapidly become greater.

It has also been suggested to grow neural networks instead of designing the neural network ahead of time. This is a field known as artificial neurogenesis. Artificial neurogenesis has been demonstrated in multiple ways. For example, a deep learning neural network can have neurons added to allow learning of new information beyond the original design and training of the network. In another example, neural networks have been grown from single neurons to learn information and for use in generalization. It has been suggested that neural networks grown through neurogenesis can learn information with fewer neurons than neural networks with a predefined layered structure.

### SUMMARY OF THE INVENTION

In an example, for a neural network including at least one neuron, a method of growing the neural network comprises providing information to the neural network for training during which training the neural network learns at least a first amount of the provided information. The method also includes detecting a limit to an information capability of the neural network. The detecting may include taking into account learning events and detecting and ignoring false limits to network learning. The method may also include determining a network growth factor. The growth factor may be responsive to a second amount of the provided information that the neural network was not able to learn and a measurement of a learning error. If the information capability of the neural network is less than a total amount of the provided information, the method may grow the neural network by adding a set comprising at least one additional neuron to the neural network. The number of additional neurons in the set may be responsive to at least the growth factor. The above steps may be repeated until the neural network learns all of the provided information. An example neural network resulting from the above steps comprises elemental neurons interconnected in an amorphous structure.

In an example, a neural network is provided comprising interconnected neurons, at least some first interconnected neurons providing inputs to second interconnected neurons, and at least some interconnected neurons receiving outputs from the second interconnected neurons. Within each interconnected neuron, an activation function is provided.; wherein each second interconnected neuron's activation function is activated independently by the inputs provided by its first interconnected neurons, and wherein the neural network stores information from a training. In addition, the neural network may provide generalizations in response to neural network input signals.

In another example, a neural network is provided comprising a network of interconnected elemental neurons that provide a signal stream from an input to an output, wherein each interconnected elemental neuron includes an activation function, input weights connected to either an information input or first other elemental neurons, wherein the first other elemental neurons connected to the input weights of the each neuron are upstream neurons with respect to the each neuron and the each neuron is a downstream neuron with respect to those upstream neurons, and output connections connected to input weights of second other elemental neurons, wherein the second other elemental neurons connected to the output connections are downstream neurons with respect to the each neuron, and the each neuron is an upstream neuron with respect to those downstream neurons. In the neural network each elemental neuron is downstream with respect to its upstream neurons and upstream with respect to its downstream neurons. In addition, each elemental neuron is activated in response to completion of the activation functions of its upstream neurons. The resultant neural network is amorphous in shape and stores information from a training. In addition, the neural network may provide generalizations in an output in response to neural network input signals.

In another example, a neural network is provided comprising multiple neurons including a subset of neurons comprising a majority of the multiple neurons, wherein each neuron of the subset of neurons has upstream neurons and downstream neurons interconnected through connections in a manner such that the connections for each neuron to other neurons are unconstrained within defined limits so that the neural network has an amorphous shape that is not predefined within the constrained limits.

### BRIEF DESCRIPTION OF DRAWINGS

FIG. 1 illustrates an example prior art neural network.

FIGS. 2-10 illustrate an example of a neural network progressively grown through artificial neurogenesis according to an example herein.

FIG. 11 illustrates example method steps for artificial neurogenesis.

FIG. 12 illustrates example method steps for adding a neuron to an amorphous neural network.

FIG. 13 illustrates example method steps to add weights to an amorphous neural network.

FIG. 14 illustrates example elemental neurons and weights and their functionality.

FIG. 15 illustrates another example of elemental neurons and weights.

FIG. 16 illustrates example operations of elemental neurons and weights when processing information.

FIG. 17 illustrates example operations of elemental neurons and weights during an example feedback for training.

### DETAILED DESCRIPTION OF THE INVENTION

Referring now to FIG. 2, an initial or genesis neural network for learning a set of data is shown. In this example the neural network is trained and will grow to learn a set of example data (in one example, financial data). The inputs of the neural network 102 are connected by a set of weights 122 to the initial neuron 176 and the neuron 176 is connected by a weight to the output neuron 177. The neural network 100 flows information in the direction of arrow 123 for forward propagation and in the opposite direction during feedback. The input neurons 122 shown are simplified and represent an initial set of 176 input neurons providing example input financial data for the network.

In the description below, a weight 122 is sometimes referred to as a connection. The reference to the direction of information flow refers to information flow during forward propagation, unless otherwise specified. Upstream is used to refer to upstream in the direction of information flow during forward propagation and downstream is used to refer to downstream in the direction of information flow during forward propagation. The weights connecting a particular neuron to upstream neurons are referred to as the input weights for that particular neuron. The connections from a particular neuron to the weights of downstream neurons are referred to as the output connections of the particular neuron. The information provided by a particular neuron to weights connected to the information output is referred to as the output of that particular neuron and also as the input of downstream neurons connected to the particular neuron by weights. In the examples herein, the neurons are also sometimes referred to as elemental neurons. In an example, elemental neurons may move positions relative to the direction of information flow during growth of the neural network and may operate in a neural network that does not have a predetermined shape (e.g., the network does not have predefined layers of specified sizes and, for a given example neuron, input weights are connected to upstream neurons at varying depths upstream of the given neuron; in this manner the network is at least in part, amorphous). In the discussion below, when a neuron is said to add a connection, it means that the growth control program added a weight connecting that neuron to another neuron. When a neuron is said to sever or lose a connection, it means that the growth control program removed a weight connecting that neuron to another neuron. An iteration, or epoch, means the processing of all of the training data (or all of a subset of training data if using subsets) for one cycle through the neural network.

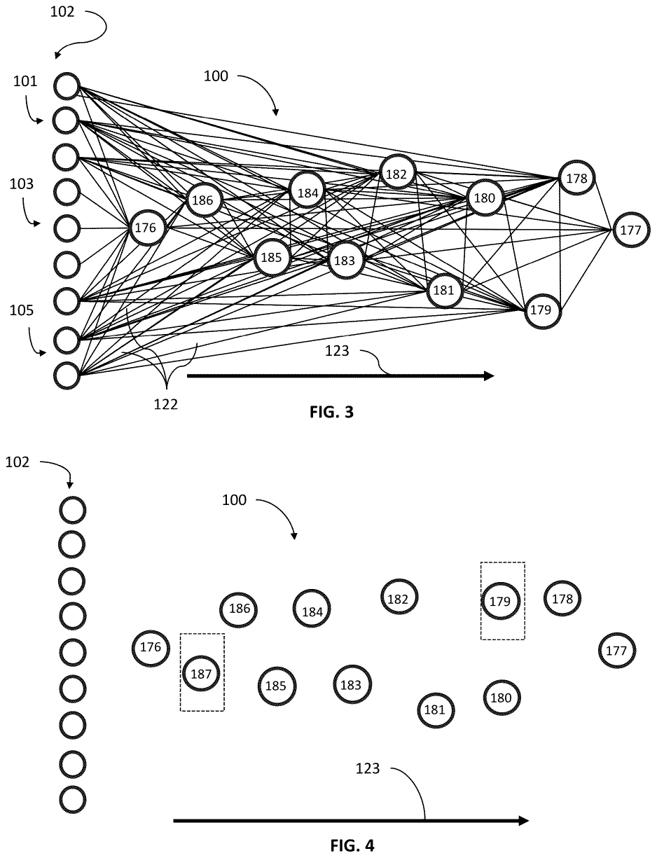

The input data set to the neural network 100 includes 176 data points for each day of data (in one example, financial data is used). In the example shown for FIGS. 2 through 9, the neural network grows as it learns 160 days of the data. In the example illustrated, each successive FIG. 3 through 9 shows new growth of the neural network that represents new learning capabilities of the neural network. After each growth the neural network learns additional days of data that it was not able to learn prior to the additional growth.

Referring now to FIG. 3, the neural network 100 is shown having grown by adding neurons 178 through 186. As can be seen the neurons 178 through 186 are not arranged in a conventional structure of layers that are fully interconnected. Each of neurons 178 through 186 is connected to first portions of the input neurons and not connected to other portions of the input neurons. For example, portions 101 and 105 are interconnected with the neurons 178 through 186 while the portion of input neurons 103 is not connected to the newly added neurons 178 through 186. Each of neurons 178 to 186 is connected to a subset of this group of neurons upstream of it. Individual neurons may be fully connected to their upstream neurons or selectively connected to their upstream neurons (meaning connected to some upstream neurons, but not others).

The arrow 123 shows the direction of information flow during forward propagation. The information starts with the input neurons 102 and flows (through the weights) to neuron 176 and also directly to the other neurons 178 to 186 to which some of the input neurons are interconnected. Each neuron 178 to 186 does not provide its output until all neurons upstream of it (using the direction indicated by arrow 123 as reference, the arrow pointing in the downstream direction) have processed their information. After neuron 176 processes its information, neuron 186 processes its information, then neuron 185 processes information, then in order neurons 184, 183, 182, 181, 180, 179, 178 process information, and then finally the output neuron 177 provides its output. With this configuration the neural network learned 60 of the 160 days of an example financial data set.

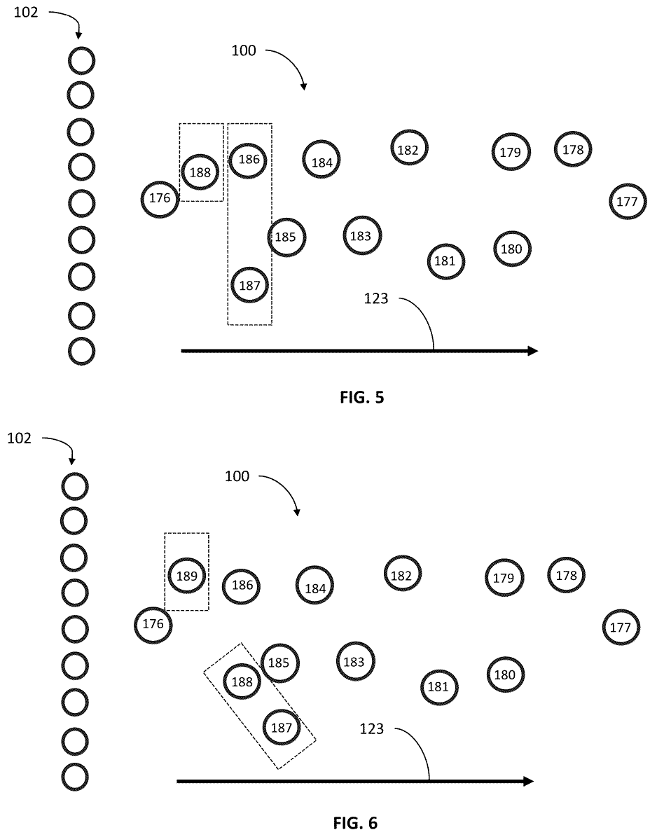

Referring now to FIG. 4, the next phase of the neural network growth is illustrated. In this growth phase neuron 187 is added upstream of neuron 186 and downstream of neuron 176. Also in this growth phase neuron 180 loses its connection with neuron 179 (e.g., the connecting input weight is removed) and becomes parallel in the flow of information with neuron 179. In this illustration and in the illustrations for FIGS. 5 through 9, the neuron connections (weights) are not shown to make the illustration clearer to see the positions of the neurons as the network grows, but it is understood that the neurons are interconnected similarly to those connections shown in FIG. 3. At the growth stage shown in FIG. 4, the neural network 100 learned 138 days of the example input financial data.

Referring now to FIG. 5, the next phase of growth of neural network 100 is shown. At this point a new neuron 188 is added downstream of neuron 176 and upstream of neuron 186. Also neuron 187 moves position in the information flow due to the severing of its connection (weight) with neuron 186 so that it is parallel with neuron 186 in the information flow. In the configuration shown in FIG. 5, the network 100 learned 147 days of the input financial data.

Referring now to FIG. 6, an additional neuron 189 is added to the network downstream of neuron 176 and upstream of neuron 186. Neuron 187 has lost a connection with neuron 185 and its position in the information flow has moved so that it is parallel with neuron 185. Additionally, neuron 188 has lost a connection with neuron 186 moving it into position in the information flow where it is parallel with neuron 186. The configuration shown in FIG. 6 learned 159 days of the input financial data.

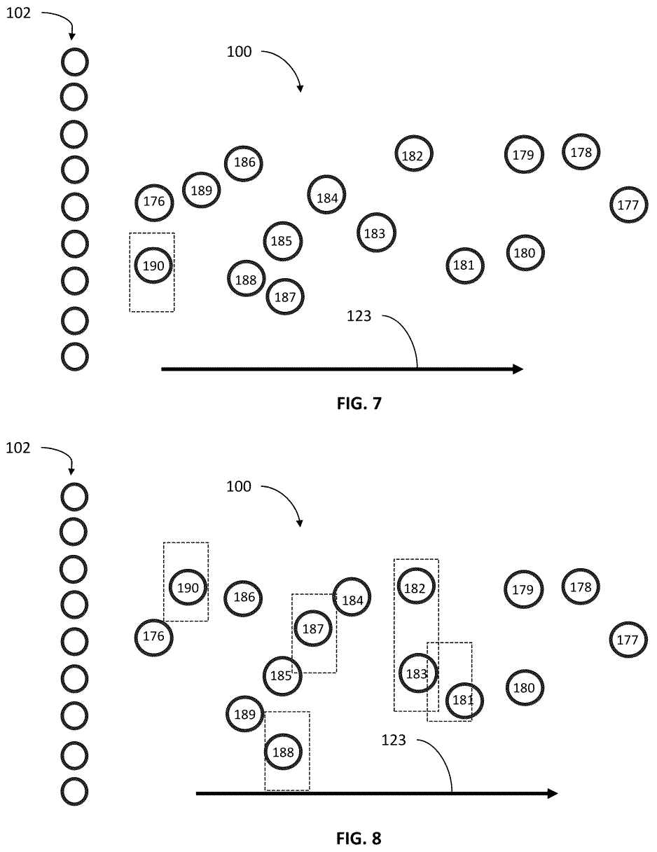

Referring now to FIG. 7, the next growth phase of the neural network is shown with new neuron 190 added parallel in the flow of information to neuron 176.

Referring now to FIG. 8, the neural network has severed some weight connections and added some weight connections with the result that neuron 183 is now parallel in the direction of flow with neuron 182. In addition, neuron 187 has an added connection with neuron 185 and is now downstream of neuron 185. Neuron 188 has severed its connection with neuron 185 and is now parallel in the direction of information flow to neuron 185. And neuron 189 has severed its connection with neuron 186 and is now parallel in the direction of information flow with neuron 186. Finally, neuron 190 established a connection with neuron 176 and is now downstream of neuron 176 and upstream of neuron 186.

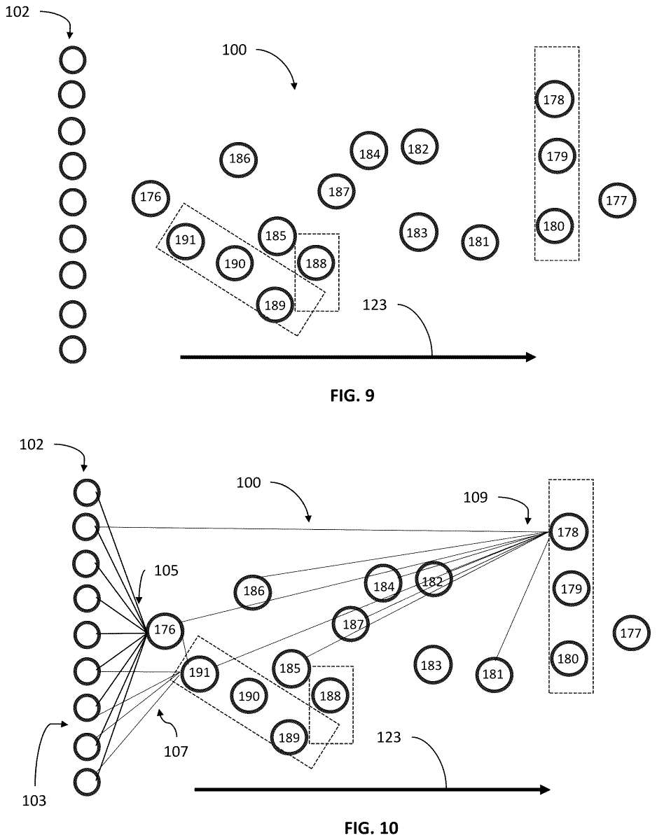

Referring now to FIG. 9, the final growth stage of this network as it learns 160 days of financial data is shown. Here neurons 179 and 180 have severed their connections with neuron 178 and are now parallel with neuron 178 in the direction of information flow. Neuron 188 has established a connection with neuron 185 and is now downstream of neuron 185 and upstream of neuron 187.

Neuron 189 has severed a connection with neuron 185 and is now parallel in the information flow with neuron 185. Similarly, neuron 190 has severed a connection with neuron 186 and is now parallel in the direction of information flow with neuron 186 and new neuron 191 is added upstream of marine 186 and downstream of neuron 176. The neural network with the neurons shown learned the 160 days set of financial information provided to the network.

In this manner, the neural network 100 shown comprises a network of interconnected elemental neurons 176-191, that provide a signal stream from an input 102 to the output 177. In a preferred example, each interconnected elemental neuron includes an activation function (described below), input weights (not shown in FIG. 9) connected to either an information input 102 or first other elemental neurons wherein the first other elemental neurons connected to the input weights of the each neuron are upstream neurons with respect to the each neuron and the each neuron is a downstream neuron with respect to upstream neurons. For example, neuron 176 is upstream with respect to neuron 191 and neuron 191 is downstream with respect to neuron 176, and so on. The neurons 176-191 are shown in their respective upstream and downstream positions with reference to arrow 123 showing the direction of information flow during forward propagation.

Each neuron has output connections connected to input weights of second other elemental neurons, wherein the second other elemental neurons connected to the output connections are downstream neurons with respect to the each neuron, and the each neuron is an upstream neuron with respect to the downstream neuron. Thus for example, for purpose of this description, neuron 176 is a first other elemental neuron connected to the input weights of neuron 191 and neurons 186 and 190 are second other elemental neurons connected to the output connections of neuron 191 (as are neurons 179 and neurons 179-189). Neurons 186 and 190 are downstream neurons of neuron 191. At each position in the information flow of the neural network, each given elemental neuron is downstream with respect to neurons that must process their outputs prior to the given elemental neuron and is upstream with respect to each neuron that cannot process its output prior to the given elemental neuron making its output available. A neuron that does not require its output to be processed prior to the given neuron processing its output and that can process its output without reliance on the output of the given neuron is neither an upstream nor downstream neuron with respect to the give neuron; instead it is parallel in the direction of information flow with the given neuron. As described below, each elemental neuron is activated in response to completion of the activation functions of its upstream neurons. The neural network 100 is amorphous in shape meaning that it is not defined by conventional layers. In a preferred example, the shape may change during training and growth. Once trained to store information, the neural network may be used to retrieve information and provide generalizations in response to neural network input signals.

To implement the amorphous neural network of FIG. 9 with conventional hardware, it may be helpful to consider the neurons arranged in virtual layers. While the virtual layers differ from conventional neural network layers that are typically fully interconnected on a successive layer basis, the virtual layers help define flow through the network and arrangement of matrix calculations through the amorphous neural network. The example shown in FIG. 9 has eleven virtual layers not including the input layer. The virtual layers in order during forward propagation are as follows: (1) neuron 76, (2) neuron 191, (3) neurons 186 and 190, (4) neurons 185 and 189, (5) neuron 188, (6) neuron (187, (7) neuron 184, (8) neurons 182 and 183, (9) neuron 181, (10), neurons 178, 179, and 180, and (11) neuron 177. As will be apparent to one skilled in the art, the virtual layers operate in reverse (from (11) to (1)) for back propagation.

Referring now also to FIG. 10, one approach to implementing the amorphous neural network in conventional hardware includes a control program that controls progress the forward and backward propagation through the network. When an input set of data from input neurons 102 is available, the control program makes that data available to the first virtual layer, which is neuron 176. The input data may be provided through conventional computational processes, such as matrix multiplication known to those skilled in the art to multiply the input data elements by the respective input weights 105 for neuron 176 and summing the result as the hidden sum in neuron 176. This hidden sum is then operated through the activation function in neuron 176 (activation functions are well known in the art) to provide the output of neuron 176.

Once the output of neuron 176 is calculated, the control program indexes to the next virtual layer (layer (2)), made up of neuron 191. Neuron 191 is connected to neuron 176 and a subset 103 of the input neurons 102, with the connections shown by reference 107 (also representing the input weights to neuron 191). The control program sends the output of neuron 176 and the data from input neurons 103, multiplies each by the respective input weights 107 of neuron 191, sums the result in neuron 191 as the hidden sum, and applies the activation function in neuron 191 to provide the output of neuron 191. The control program continues this way during forward propagation providing to each virtual layer (3)-(11) the information flow through the network.

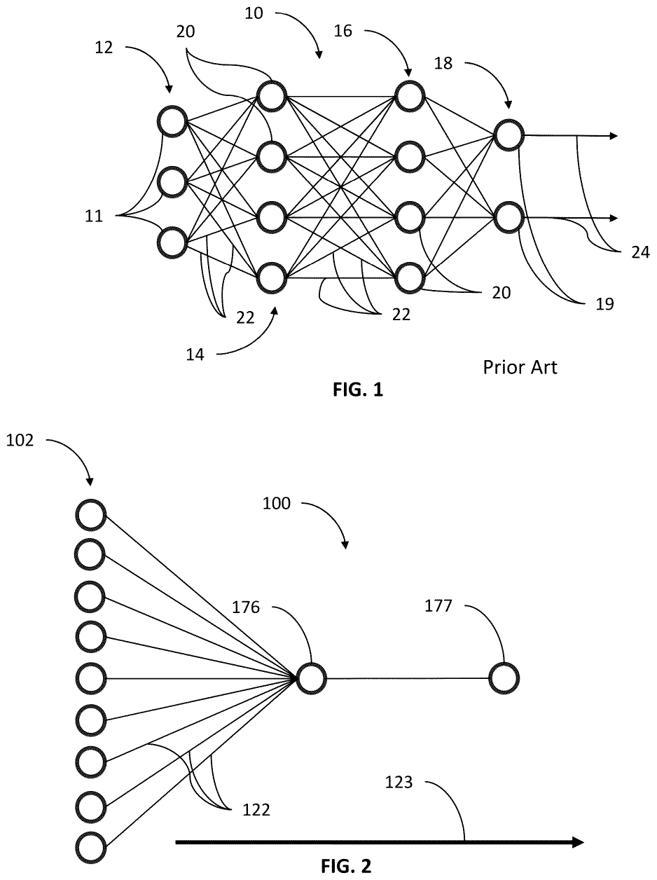

FIG. 10 helps illustrate the amorphous nature of the neural network. FIG. 10 shows example connections for neurons 176, 191, and 178, and omits the connections for the other neurons for purposes of this discussion. While neuron 176 in layer (1) is connected to all of the input neurons 102 via weights 105 in a conventional manner, neuron 191 is connected to both layer (1) neuron 176 and a portion 103 of the input neurons through weights 107. Similarly, for illustrative purposes, neuron 178 is shown with its example input weights 109. Neuron 178 is part of virtual layer (10) and the input weights 109 connect to various neurons in prior virtual layers including neurons 181, 182, 184, 187, 185, 186, 176, and a minor portion of input neurons 102. Using neurons 191 and 178 as examples, the difference between the neural network in FIG. 10 and the example in FIG. 1 can be readily seen. FIG. 1 illustrates a neatly defined and readily apparent layer structure of neurons and weights. On the other hand, FIG. 10 has no neatly defined or readily apparent layer structure, which is why the network in FIG. 10 is referred to as amorphous. It will also be understood that neurons 191 and 178 are illustrated with their weights shown to explain the amorphous nature of the neural network. The weights for the other neurons are omitted from the illustration. It is understood that the neurons and weights in each of the layers (2)-(10) are similarly structured in that (a) they are not strictly constrained to a predefined layer structure and (b) each neuron typically connects to multiple prior layers.

If using a control program in conventional hardware, the control program also controls information flow during back propagation in the direction from layer (11) to layer (1) and the input layer to train the weights for the neural network. During back propagation, the control program controls each individual neuron in a given layer to perform its learning function when all of the neurons to which it is connected by weights in higher layers have performed their learning function. To assist in the forward and back propagation, the control program may use indexes of weight connections for each neuron. For example, for a given neuron, the control program may have (a) an index of each of the neuron's input weights, and of each prior layer neuron to which each input weight is connected, and (b) an index of each input weight of higher layer neurons that are connected to the given neuron's output, and each higher layer neuron for which each of these weights are the input weights. The control program may use these indexes to track completion of forward and backward propagation functions through the virtual layers.

Viewing the neural network in FIG. 10, the neural network comprises multiple neurons including input neurons, 102 and neurons 176-191. In this example, neurons 176 and 178-191 are a subset of neurons comprising a majority of the multiple neurons in the network. As described above, each of the neurons 176 and 178-191 has upstream neurons and downstream neurons interconnected through connections, represented by the various weights, including weights 105, 107 and 109 shown and weights not shown but understood to be there by one skilled in the art in view of the discussion above. As described above, the connections for each neuron to other neurons are unconstrained within defined limits so that the neural network has an amorphous shape that is not predefined within the defined limits. The defined limits may include (1) a maximum number of input weights per neuron, (2) a minimum number of input weights per neuron, (3) a maximum number of output connections per neuron, (4) a minimum number of output connections per neuron, and (5) variations in the aforementioned maximum and minimum numbers based upon the depth (e.g., virtual layer) of the neuron in the network. For example, for a network performing a classification function, the maximum amount of input connections and output connections for a neuron may be reduced for neurons located more downstream in the flow of forward propagation (e.g., in higher virtual layers). Another defined limit may be the network proximity of at least some connections of at least some neurons. For example, as the network grows in depth, new neurons or new weights (connections) added to existing neurons may have the depth of their new connections towards upstream neurons limited. For example, with reference to FIG. 10, if new weights are added to neuron 178, or if, for purposes of discussion, neuron 178 is assumed to be a newly added neuron, its input weights may be limited to connect as far upstream (in the direction of forward propagation) as neurons 186 and 190 (virtual layer (2)), but not as far upstream as the input neurons or neurons 176 and 191. These defined constraints are illustrative in nature and are not meant to be limiting as other defined constraints may occur to one skilled in the art that provide outside boundaries within which the neural network has an amorphous shape or configuration.

As will be understood by one skilled in the art, the amorphous neural network such as shown in FIG. 10 may be a stand-alone network or a unit of a larger network. If part of a larger network, the inputs to the amorphous neural network may be outputs of an upstream network component of the larger network and the outputs of the amorphous neural network may be inputs to downstream network components of the larger network.

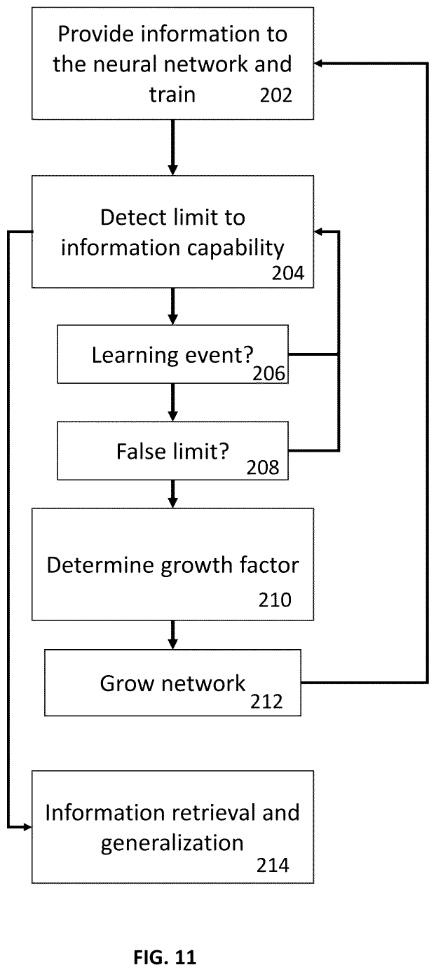

Referring now to FIG. 11, a neurogenesis method or method of growing a neural network to learn information is shown. The steps shown are performed by controls that may be implemented in hardware, software, or a combination of the two, the specific steps being within the skill in the art taking into account the explanation herein. Starting at block 202, information is provided to an infant or genesis network, such as shown in FIG. 2, for training. During the training the neural network learns up to a first amount of the provided information. During this step shown in block 202 the training is of the type appropriate for the type of neural network being built. One example includes supervised learning. Another example includes unsupervised learning, such as when building an autoencoding neural network.

At step 204 the neural network detects the limit of the information capability of the network. As is known in the art, during learning a neural network has an error for each piece of information to learn and a total error for the total information set. Generally, detecting a limit in the information capability of the network may include detecting that the network has reached a learning limit which may be indicated by the total error of the network reaching a plateau at which it does not fall below. A learning limit may also be indicated by the network plateauing in the number of information items (e.g., in the financial example above, a certain number of days of information) that the network learns to a predetermined error.

Moving now to step 206, the network during learning and detection determines whether it is in the middle of a learning event. A learning event may occur such as when the network has changed due to the growth, or neurogenesis. For example, when new neurons are added to the network, it may cause a temporary disruption and the total error of the network may temporarily increase until the network adjusts to the new neurons and begins learning additional information based on the additional capability that the additional neurons provide to the network. A learning event may also occur if the neural network has had a structural change due to addition or subtraction of connections, or weights, which interconnect the neurons. One method for addressing the learning event is to prevent step 204 from signaling a limit to the network information capability, or to override step 204, for a period of learning iterations of the neural network after the occurrence of the learning event. This override will allow the neural network to recover from any disruption that the learning event may have introduced and continue learning new information until the learning limit is reached.

Also during learning, step 208 illustrates the detection of whether the neural network has reached a false limit and if so, the neural network will not indicate a limit to the information capability of the network. For example, it is not unusual for a neural network during learning to reach lows in total error or pauses in the reduction of total error, and for the total error to temporarily rise as the neural network adjusts itself to learning the information set. False limits may be temporary in nature in which case they may be detected and addressed by prohibiting the step 204 from signaling a limit to the learning capability of the network unless that limit is sustained for a predetermined number of iterations of the network. Accordingly, if a learning event is detected at step 206 or a false information limit is detected at step 208, the method does not determine that the neural network has reached the limit of its information capability and continues the learning cycle.

If step 204 determines that the neural network has reached the limit of its information capability and is not in a learning event as determined by step 206 or at a false limit as determined by step 208, step 210 determines a growth factor for the neural network.

The growth factor at step 212 can be represented as a number and may be determined by one or more of the following factors: the amount of information learned by the neural network compared to the total information in the input information set, the size of the error at which the neural network stopped learning, and the size of individual errors for information sets (e.g., in the example of financial data above, the size of error for individual days of data). Once the growth factor is determined at step 210 the method grows the neural network at step 212 by adding neurons to the network. The addition of neurons to the network may be done in a variety of manners. In one example, neurons are added to the most active connections in the network. The active connections in one example may be indicated by the size of the weights connecting the neurons, with larger weights potentially indicating a larger impact of that connection on the neural network. Active connections in another example may be determined by the total number of active weights connected to a neuron. In another example, the network can be grown by randomly adding neurons and connections in the network. When weights are added to the neural network, either to connect new neurons into the network or to add additional weights to existing neurons, their starting values of the weights may be determined randomly, such as, for example, randomly selecting a value between 0 and 1 for each weight. The weight starting values may be determined through other means and need not be randomly determined. It is preferred to have a variety of initial values in a new weight set and it is preferred that a neuron not be duplicated with its weights as identical reproductions to weights of the existing neuron in a manner that may make the original and new neuron behave in lockstep with each other. After the network is grown at step 212, the processes represented by steps 202 and 204 are continued repeatedly, including steps 206, 208, 210 and 212, as necessary until the neural network is capable of learning the entire information set.

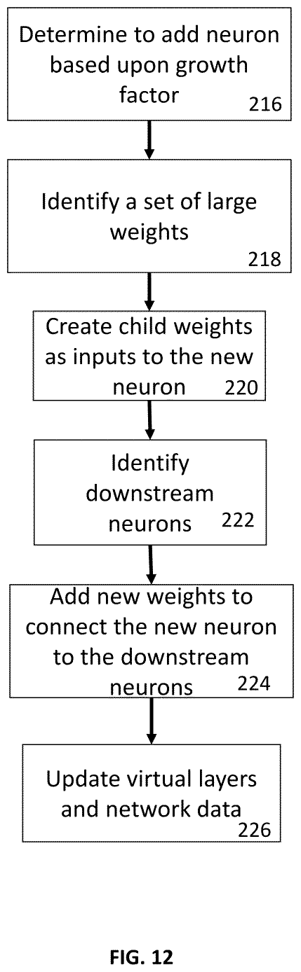

FIG. 12 illustrates example steps of adding a neuron to the network. At step 216, the method determines to add a neuron, for example, based upon the growth factor determined at step 210 in FIG. 11. At step 218, the method indexes through the various weights and identifies a set of weights that have relatively large values. Alternatively, the weights can be selected randomly. For each weight identified at step 218 (each referred to as a parent weight), a new weight is created at step 220; the new weight is referred to as a child weight. The child weight connects to the same neuron output to which its parent weight connects and serves as an input weight to the new neuron. Once the input weights are determined, step 222 identifies neurons that are downstream of the neurons that are upstream (in the direction of forward propagation) of the new neuron. From the set of downstream neurons, a subset is selected (unless the set is very small, in which case all may be selected). The selected downstream neurons can be determined at random or by a qualitative factor, such as the neurons with the least number of input weights. At step 224, the method creates a new input weight for each of the selected downstream neurons and connects that weight to the output of the new neuron. Once this step is completed, the control program updates the network information and the network can return to training (step 202 in FIG. 11).

If a control program is used with conventional hardware, the control program updates the virtual layers and the indices identifying connections between neurons. The virtual layers may be identified as follows: (a) during forward propagation, neurons that have input weights connected solely to the input neurons are virtual layer (1); (b) neurons that have input weights connected solely to virtual layer (1) neurons and the input layer are virtual layer (2); (c) neurons that have input weights connected solely to virtual layer (2) neurons and neurons upstream of virtual layer (2) are virtual layer (3) neurons, etc. Each successive virtual layer (e.g., (4), (5) . . . ) is determined in the same manner and generically defined as relying upon the output of at least one neuron of its prior virtual layer and 0 to n neurons of further upstream virtual layers (where n is <=the total number of neurons in the upstream layers). When the virtual layers are determined after growth of the network, preexisting neurons may no longer be in the same virtual layers they were previously and thus may have appeared to have moved to a different virtual layer.

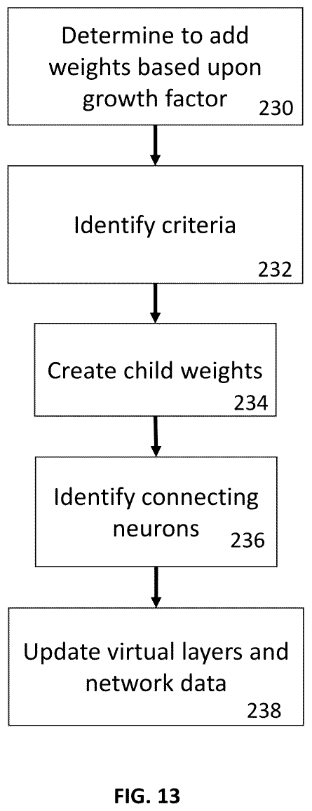

Referring now to FIG. 13, in addition to, or in alternative to the steps for adding new neurons, the method may add weights to the neural network in response to the growth factor. The steps for adding weights start at step 230 where the growth factor determines to add new weights. This determination may be made automatically when new neurons or added, in response to a desire to make smaller increments in learning capability of the network, or based upon the weight to neuron ratio. The locations in the network to add weights may be determined by a variety of criteria. Neurons can be selected randomly, or weights can be added based upon the numeric size of inputs or outputs of neurons. For example, if a neuron typically has a large output value but connects to a limited number of downstream neurons, a new weight can be added connecting that neuron to the additional downstream neurons. The new weights are called child weights and are added to the neurons identified (step 234) by one of the aforementioned approaches. The other neuron connection of each child weight may similarly be selected by a variety of approaches at step 236. If the child weight is already associated to an input of an existing neuron (parent neuron), the child weight is connected to the output of another neuron of equal or lower (upstream) virtual layer as the parent neuron. If the child weight is already associated with an output of an existing neuron (parent neuron), the child weight is connected to the input of another neuron of equal or higher (downstream) virtual layer as the parent neuron. This other neuron to which the child weight is connected may be selected randomly or by a qualitative factor such as, the number of input or output connections of that neuron, or the value of the hidden sum or output of a neuron. For example, a child weight added to the output of a parent neuron that has a high output value may be added to the input of a neuron that has a relatively low output value. The result of steps 234 and 236 is the addition of the new weight. After the desired weights are added, the network data and virtual layers are updated (step 238) in the control program and the network resumes training (step 202 in FIG. 11).

In an example, the neural network may actively grow and trim connections (weights) during growth and learning. Weights may be trimmed, or removed, if they have values insignificant compared to other weights connected to a particular neuron. Weights may be added to either output connections or as input weights to a neuron if (a) there are candidate neurons to add connections to (e.g., neurons not already connected to the particular neuron) and (b) the number of weights or connections to a particular neuron is less than a determined number. The total number of weights or connections for a particular neuron may be a function of where the neuron is in the information flow. For example, neurons closer to the input information may have a determined maximum number for input weights greater than those closer to the output of the neural network, keeping in mind that strict conformity to this determination is not necessary and there may be benefits to introducing a level of randomness in this determination.

Referring again to FIG. 11, if at step 204 the method determines that the neural network has grown to a capability to learn the entire information set, the method proceeds to step 214, where the neural network is used for information retrieval and generalization. As is known in the art the neural network may be used as a standalone information retrieval and generalization function or maybe combined into larger structures for more complex AI tasks known to those skilled in the art.

Using the network in information retrieval and generalization may involve moving the weights and neuron structures to new hardware as is known in the art, for example, hardware dedicated to information retrieval and generalization and not needing the functionality of training. Information is retrieved from the network by providing an input information set that forward propagates through the network to the output, which is the retrieved information. Generalization occurs in a similar manner, except the information provided to the network is of a category similar to the information on which the network is trained but not identical to the training information. The output of the network may be, for example, a categorization (e.g., of an image or other type of data) of the input data.

In an example, the above process is carried out by introducing the information or data to the network in subsets. Thus in the example of training 160 days of financial data, an initial number of days of data or information less than 160 is used to train and grow the network. The number of days of data or information is increased in increments as the network learns the subsets of information presented to it during training until the network has grown and learned the entire data set.

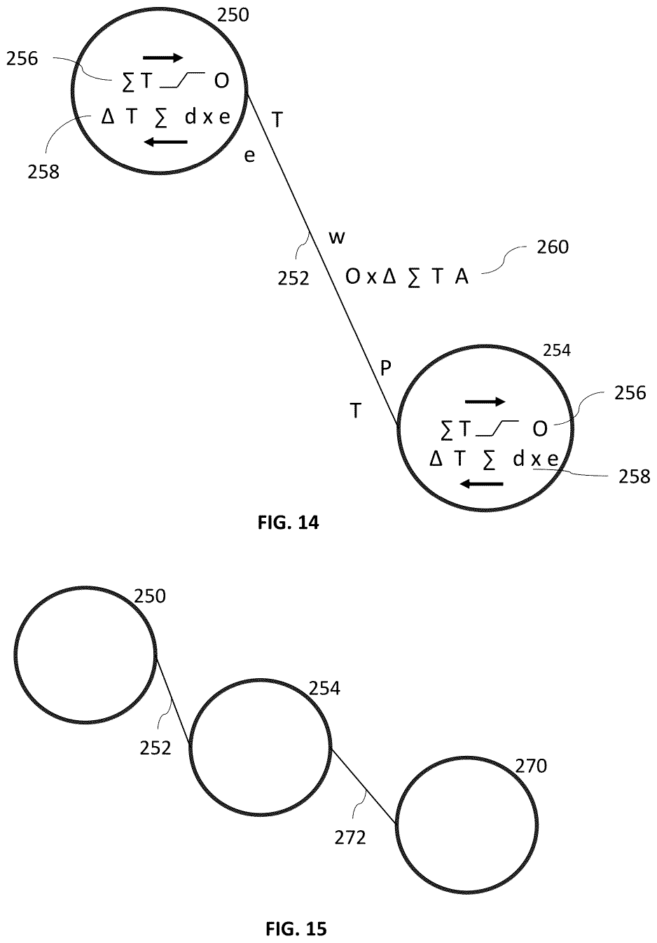

Referring now to FIG. 14, example structure within a neural network is shown in a simplified drawing that illustrates two of the many neurons in the network and one interconnecting weight. The two neurons 250 and 254 are interconnected by weight 252. In one example, the neural network is made-up of neurons such as 250 and 254, which are elemental neurons controlled directly by the information flow through the neural network and not under control of a program that defines a network in layers. Alternatively, the neurons may be independent processing units defined in hardware and configurable to the processes described. Reference 256 illustrates the functions of each neuron during forward propagation of the neural network and reference 258 represents the functions of each neuron during back propagation. The forward propagation functions of each elemental neuron include (a) the summation of the product of the weights multiplied by the output(s) of the upstream neuron(s), (b) the detection that all the products of the input weights to the neuron have been received, (c) the activation function of the neuron, and (d) the output which is the result of the activation function operating on the summation of the products provided by the weights.

The direction of information flow during forward propagation in this example is from neuron 250 through weight 252 to neuron 254 and then to the output of neuron 254. In this example neuron 250 is upstream of neuron 254 and neuron 254 is downstream of neuron 250. While two neurons are shown, it is understood that the neural network could have many or even thousands of neurons, and each neuron could have many or thousands of connections through weights to upstream neurons (unless the connection is directly to an information input, or input neuron) and each neuron may have many or thousands of connections from its output to weights leading to downstream neurons (unless it is an output neuron providing an information output, which in many examples do not have downstream neurons). For example, the operation of neurons 250 and 254 are representative of the operation of neurons 176 and 177-191 shown in FIG. 9.

In operation, neuron 250 provides its output, weight 252 detects this available output and the weight 252 multiplies that output by its weight value to create a product that is provided to neuron 254. Other neurons (not shown) similar to neuron 250 upstream of neuron 254 are connected to neuron 254 by weights. Those other neurons provide their outputs to other weights (not shown) which operate like weight 252 to provide the product of the neuron outputs and the respective weight values to the input of neuron 254. Within neuron 254 each provided product is summed to the other provided products. Neuron 254 contains a trigger function that detects when all the available products from the connected weights are provided to neuron 254. Once all the weight products are received in neuron 254 and summed the result of this summation is provided through the activation function of neuron 254. The activation function in neuron 254 may be any activation known to those skilled in the art and selected by the neural network designer. The result of the activation function is the output of neuron 254 represented by the letter O in the operations 256. In this manner, each weight in the neural network self-activates and each neuron in the neural network self-activates when the signals are available from their respective upstream sources. That is, weight 252 activates when the output is available from neuron 250. And neuron 254 activates when all of the products from all of the weights connecting neuron 254 to its upstream neurons provide their products to the input of neuron 254. Similarly, the output of neuron 254 triggers the activation of the weights connected from the output of neuron 254 to the next (downstream) neurons in the information flow.

During training information flows not only in forward propagation from neuron 250 through weight 252 to neuron 254, but also in back propagation from neuron 254 through weight 252 to neuron 250 for error correction. The information flow during back propagation similarly operates in a self-activation manner as during forward propagation. For example, each neuron calculates a delta which will be described further below and provides that delta to its input weight. So in the case of neuron 254, during backpropagation, it provides a delta to the weight 252. When the weight 252 senses that the delta is available for neuron 254, weight 252 multiplies the value of that delta by the value of the weight 252 to provide an error signal to neuron 250. Neuron 250 multiplies that error signal by the derivative of its output and sums the result of that product along with the product from any other weights similarly connected to neuron 250, keeping in mind that the illustration is a simplified illustration of two neurons but in practice weight 250 has multiple weights similar to weight 252 each connected to a respective downstream neurons. When all the errors are received in neuron 250 by weights such as weight 252 and summed together, trigger function in neuron 250 provides a delta is the result of the feedback function for that neuron. Thus in the flow of information during feedback the availability of the delta from the neuron such as 254 triggers the weight 252, which provides the error to neuron 250, which when it receives all of the errors from its respective weights computes the delta to provide to its upstream neurons through its input weights.

Also during feedback, the weight computes its adjustment in a manner known to those skilled in the art but in this case is an elemental function the weight itself. For example, weight 252 multiplies the delta from neuron 254 provided during feedback by the output of neuron 250 that was provided during forward propagation and sums that product with the similar product from each piece of information in the information set during feedback. With each iteration of the information set the combined result is provided as a correction to the weight 252. The calculations to carry about the above described operations, such as to calculate the delta, error, and weight adjustments, are known to those skilled in the art as are any details not expressly described above.

In the case where the upstream neuron is an input neuron, that neuron functions to provide the input information as the output to its connected weight. Thus if neuron 250 is an input neuron its output is the input information (which may be scaled appropriately as is known in the art) and the output is provided to the weight 252 during forward propagation. During back propagation typically there is no need to calculate a delta for an input neuron.

In the case where neuron 254 is an output neuron, the error for the output neuron is computed as the difference between the actual output and the expected output of the output neuron.

Referring now to FIG. 15, this example illustrates a neural network comprising interconnected neurons, of which neurons 250, 254, and 270 are representative. Only the three neurons 250, 254, and 270 are shown for purposes of explanation, with the understanding that they may be part of a larger neural network that may include many or thousands of neurons. The output of the first neuron 250 provides input to the second neuron 254 through the weights 252. Neuron 270, as well as other neurons not shown, receive outputs from the second interconnected neuron 254, as well as from other neurons not shown. Within each interconnected neuron is an activation function as described above that is activated independently by the inputs provided by the outputs of its upstream neurons and connecting weights.

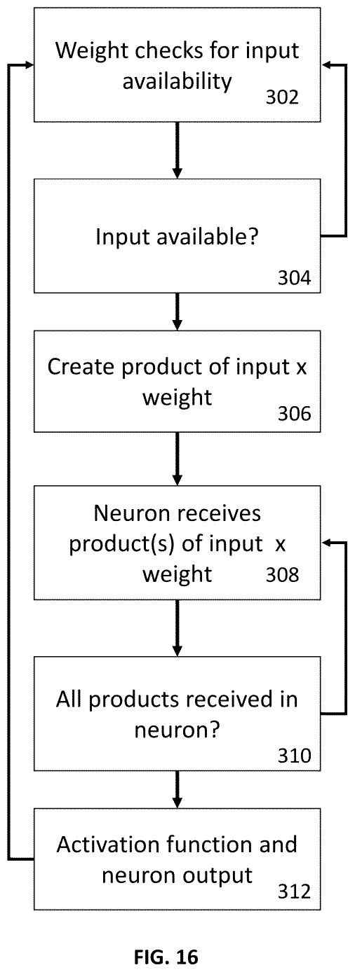

Referring now to FIG. 16, the steps shown illustrate the forward propagation steps described above with respect to the elemental neurons in FIGS. 14 and 15. Step 302 illustrates a weight checking for the availability of the output from the neuron to which it is connected to receive an output. Add step 304 if the output is available, the process moves to step 306 where the weight creates a product of that output multiplied by the value of the weight. At step 308 the weight provides that product to the neuron for which the weight is the input weight. A step 310 the neuron receiving the products of the weights and the outputs of the upstream neurons and checks whether all the products have been received, that is whether all of the input weights for that neuron have processed the outputs of the upstream neurons. At step 312 once all the products have been received the neuron processes its activation function and provides its output to its downstream neurons through their respective input weights, or in the case of the output neuron as the output of the output neuron.

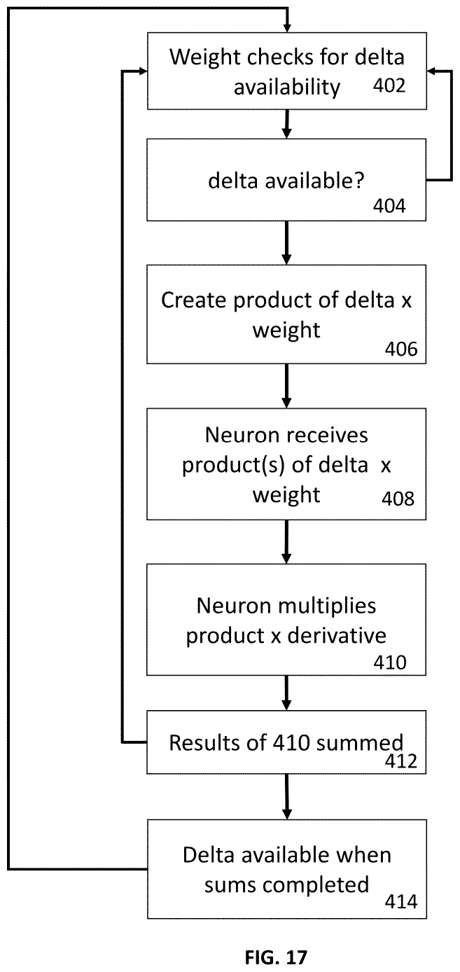

Referring now to FIG. 17, the steps shown illustrate the steps described above with respect to the feedback propagation of the neural network. At step 402, each weight checks for the availability of the delta from the neuron to which it is connected. Next step 404 determines whether the delta is available. If the delta is available, step 406 creates the product of the delta and the weight value and at step 408 provides that product to the upstream neuron as an error value. At step 410 the upstream neuron multiplies the received product by the derivative of that neuron's output. At step 412, the results of the multiplication step 410 for all of the weights back propagating to that neuron are summed. If all of the weights providing back propagation to that neuron have not yet provided their products then the method loops back to step 402 to complete the processing of all the data from the weights connected to that neuron providing back propagation information. When all of the sums have been completed for all of the downstream weights at step 412, the neuron at step 414 provides its delta available to its input weights.

1. A neural network comprising multiple neurons including a subset of neurons comprising a majority of the multiple neurons, wherein each neuron of the subset of neurons has upstream neurons and downstream neurons interconnected through connections in a manner such that the connections for each neuron to other neurons are unconstrained within defined limits so that the neural network has an amorphous shape that is not predefined within the defined limits and is capable of at least one of learning information and outputting learned information.

2. A neural network according to claim 1, wherein the defined limits include at least a maximum number of input connections to each neuron of the subset of neurons.

3. A neural network according to claim 1, wherein the defined limits include at least a minimum number of input connections to each neuron of the subset of neurons.

4. A neural network according to claim 1, wherein the defined limits include at least a maximum depth upstream of an added connection for a neuron of the subset of neurons.

5. A neural network according to claim 2, wherein the maximum number of input connections for a neuron of the subset of neurons varies in relation to a downstream depth of the neuron in the neural network.

6. A neural network comprising
interconnected neurons;
at least some first interconnected neurons providing inputs to second interconnected neurons;
at least some interconnected neurons receiving outputs from the second interconnected neurons;
within each interconnected neuron, an activation function;
wherein each second interconnected neuron's activation function is activated independently by the inputs provided by its first interconnected neurons, wherein the neural network stores information from a training and provides generalizations in response to neural network input signals.

7. In a neural network including at least one neuron, a method of growing the neural network comprising:
providing information to the neural network for training during which training the neural network learns at least a first amount of the provided information;
detecting a limit to an information capability of the neural network taking into account learning events
detecting and ignoring false limits to network learning;
determining a network growth factor based upon a second amount of the provided information that the neural network was not able to learn and a measurement of a learning error
if the information capability of the neural network is less than a total amount of the provided information, growing the neural network by adding a set comprising at least one additional neuron to the neural network, wherein the set contains a number of additional neurons responsive to at least the growth factor;
repeating the steps of a)-d) until the neural network learns the provided information;
wherein the neural network resulting from steps a)-e) comprises elemental neurons interconnected in an amorphous structure.
